(19) United States
(12) Patent Application Publication
(10) Pub. No.: US 2010/0067640 A1
(43) Pub. Date: Mar. 18, 2010

(54) High-Power-Density Lithium Target for Neutron Production

(76) Inventors: Carl A. Willis, Albuquerque, NM (US); Donald A. Swenson, Albuquerque, NM (US)

Correspondence Address: DENNIS F ARMIJO;DENNIS F. ARMIJO, P.C., 6300 MONTANO RD. NW, SUITE D, ALBUQUERQUE, NM, 87120, US

(21) Appl. No.: 12/556,169

(22) Filed: Sep. 9, 2009

Related U.S. Application Data
(60) Provisional application No. 61/096,515, filed on Sep. 12, 2008.

(51) Int. Cl. G21G 1/10

(52) U.S. Cl. 376/194

(57) ABSTRACT

A target system for producing intense epithermal and sub-MeV neutron fluxes from proton beams by the Li-7(p,n)Be-9 nuclear reaction by use of a layer of solid metallic lithium as the target material, which, in concert with a novel conical substrate to provide support and cooling, is designed to accept proton-beam power densities in excess of 1 MW m⁻². The lithium is of limited thickness so that protons exit the lithium layer after reaching the threshold of the (p,n) reaction and deposit their remaining kinetic energy in the cooled substrate. In addition, the target system is configured in a novel geometry intended to confer symmetry around the beam axis of the resulting neutron fields—a feature particularly relevant to utilization of the claimed invention in boron-neutron capture therapy (BNCT).

### RELATED APPLICATIONS

This application is related to U.S. Provisional Patent Application Ser. No. 61/096,515 entitled “High-Power-Density Proton Target for Neutron Production”, filed on Sep. 12, 2008, the teachings of which are incorporated herein by reference.

### BACKGROUND OF THE INVENTION

1. Field of the Presently Claimed Invention (Technical Field)

The presently claimed invention relates to a target, which when bombarded by an ion beam, produces nuclear byproducts.

2. Background Art

The reaction of low-energy protons with lithium to produce neutrons, commonly denoted by ⁷Li(p,n)⁷Be, has long been known as an efficient source of neutrons, and one that may be suitable for producing neutrons for the treatment of cancers by boron-neutron capture therapy (BNCT).

Heat removal and the physical properties of lithium metal have frustrated the practical use of ⁷Li(p,n) for neutron sources intense enough for BNCT. A “consensus” criterion for the minimum intensity of a treatment field for BNCT is 10⁹ neutrons cm⁻² s⁻¹ in the epithermal energy band (0.5 eV to 10 keV); this intensity requirement and other factors dictate a minimum source rate on the order of 10¹³ neutrons s⁻¹ from prospective ⁷Li(p,n)⁷Be targets, and a corresponding need to dissipate many kilowatts of heat in the target. Lithium melts at 180 degrees Celsius and has poor heat capacity in the solid state. The problem the present invention treats is the problem of designing a high-power-density solid lithium target for use in clinical BNCT.

Several examples of experimental, high-power-density, solid lithium targets described in the literature serve to illustrate the state of the art in lithium target technology. In Ludewigt B, Chu W, et al. An epithermal neutron source for BNCT based on an ESQ-accelerator. Proceedings of the Topical Meeting on Nuclear Applications of Accelerator Technology, Albuquerque, N. Mex., November 1997, pp. 489-494, it describes designing and testing the thermal performance of a planar aluminum heat exchanger upon which the intention was to vapor-deposit a 45-micron layer of lithium metal for use as a target in a BNCT treatment system. According to thermal tests, this target was expected to handle more than 30 mA of proton beam at 2.5 MeV without exceeding the melting point of lithium, satisfying the intensity requirements for BNCT. In Taskaev, S, Bayanov B et al. Development of lithium target for accelerator based neutron capture therapy. Advances in Neutron Capture Therapy 2006 (Proceedings of ICNCT-12), Kagawa, Japan, October 2006, pp. 296-299, the authors describe fabrication of a 10-cm diameter planar target that thermal tests indicate could operate with a 2.5-MeV, 10-mA proton beam. This effort identified and reported the aforementioned lifetime-limiting blistering problem with copper substrates.

Some efforts, aiming to avoid the heat removal problem associated with solid lithium, have planned for liquid lithium targets: Lone M, Ross A et al. Low energy 7Li(p,n)7Be neutron source (CANUTRON). Atomic Energy of Canada Limited AECL-7413/PASS-18-5-R (1982), proposed a gravity-contained bare molten lithium target for bombardment by 2.5-MeV protons at up to 50 mA; U.S. Pat. No. 3,993,910 described a neutron-production target composed of a “free-falling, sheet-shaped [ . . . ] liquid lithium jet” upon which energetic deuteron beams can be directed. More recently, in Randers-Pehrson G, Brenner D. A practical target system for accelerator-based BNCT which may effectively double the dose rate. Med Phys 25(6), 894-896 (1998), proposed a hybrid beryllium/flowing liquid lithium target for BNCT in which the molten lithium remains contained behind a beryllium window that itself produces significant numbers of neutrons.

Thin lithium targets have been proposed in which an incident proton beam of near-threshold energy is absorbed only to the extent necessary to decrease energy below the (p,n) reaction threshold; for instance, U.S. Pat. No. 5,870,447 and U.S. Pat. No. 6,130,926. Such ideas exploit the fact that the actual heat deposited in the target material and surrounding regions need in theory only be a small fraction of the incident beam power in order to produce maximum neutron yield for a given beam energy and current. These devices must rely on radiative and/or edge conduction cooling. Re-acceleration and recirculation of transmitted particle beam is a possible secondary benefit of this idea.

Mechanical motion to reduce effective power density and/or bring coolants into better contact with target materials has been the defining feature of some approaches to high-intensity accelerator neutron source targets. For example, U.S. Pat. No. 5,392,319 disclosed a rotating carriage having an annular region for target substances, including lithium, and that centrifugally pumped coolant against the inside wall of this annulus by virtue of the rotation. Powell's preferred embodiments (U.S. Pat. No. 5,870,447) also incorporate rotation to assist in cooling.

Explicitly because of the thermal and physical difficulties with lithium metal, recent intense accelerator-based neutron sources suitable for BNCT have often been planned with beryllium targets, as disclosed in Wang C and Moore B. Thick beryllium target as an epithermal neutron source for neutron capture therapy. Med. Phys. 21(10), 1633-1638 (1994), despite the poorer efficiency and harder neutron spectrum from ⁹Be(p,n)⁹B. Other intense neutron sources sometimes proposed as alternatives to lithium targets include light-ion fusion neutron generators and the reactions of deuterons on beryllium or carbon. Many other neutron sources have historically been mentioned in the context of BNCT; these include high-energy (>15 MeV) cyclotron beams on metals such as gold, as disclosed in U.S. Pat. No. 4,112,306, spallation neutron sources, photonuclear sources, and radioisotope sources.

The only neutron sources used in human clinical BNCT to date have been nuclear reactors.

The Ludewigt target suffers from azimuthal asymmetry and higher surface power densities for a given beam power than a conical target. The Taskaev target is azimuthally-symmetric, but requires higher surface power densities for a given beam power compared to a conical target. The copper substrate is also a lifetime-limiting component, being susceptible to blistering by implanted hydrogen that has low solubility in the metal.

Approaches involving liquid lithium are limited by several concerns. First, and most importantly, liquid lithium is corrosive to most metals including steels, aluminum, and copper. Techniques involving molten lithium face a unique and challenging containment problem that is itself an area of active research. For bare targets, the sputtering rate of liquid lithium impinged by protons is much higher than that of solid lithium, and the vapor pressure rises rapidly above the melting point. Redistribution of target material, including the radioactive ⁷Be byproduct of the (p,n) reaction, by evaporation and sputtering is a special concern for bare liquid lithium targets. Randers-Pehrson's idea avoids the evaporation and sputtering concerns, but would have lower yields for a given beam power than bare lithium. There is also a risk of the thin beryllium vacuum window breaking with serious consequences.

Approaches involving mechanical motion of the target-introduce additional complexity and additional components needed to effect the movement. Thermal cycling and the periodicity of heat addition are concerns of interest in such designs.

Non-lithium accelerator-based neutron sources of suitable intensity for

BNCT tend to suffer from contamination with high-energy neutrons that would contribute large healthy-tissue doses to patients, i.e., they result in inferior beam quality than that achievable with lithium sources. High energy neutrons not only contribute unwanted doses from scattering in the patient's healthy tissues, they also require more moderation prior to delivery and they generate more penetrating inelastic-scattering gamma radiation. In many cases this is the result of using higher incident particle energies to obtain neutron yields comparable to ⁷Li(p,n)⁷Be. Neutrons from ⁹Be(p,n)⁹B with −4-MeV protons have energies ranging up to about 2 MeV; neutrons from the deuterium-deuterium and deuterium-tritium sources are roughly 2.4 and 14 MeV, respectively; spallation neutrons and those from high-energy cyclotron-driven (p,n) reactions may have energies as high as a few dozen MeV or even hundreds of MeV. For comparison, ⁷Li(p,n)⁷Be at a proton energy of 2.5 MeV produces neutrons with a maximum energy of about 0.8 MeV.

SUMMARY OF THE PRESENTLY CLAIMED INVENTION

Embodiments disclosed herein address the above stated needs by providing a target system for producing intense epithermal and sub-MeV neutron fluxes from proton beams by the Li-7(p,n)Be-9 nuclear reaction. While this reaction is well-known and has seen prior practical implementations, the novel use of a layer of solid metallic lithium as the target material, which, in concert with a novel conical substrate to provide support and cooling, is designed to accept proton-beam power densities in excess of 1 MW m⁻². In the presently claimed invention, the lithium is of limited thickness so that protons exit the lithium layer after reaching the threshold of the (p,n) reaction and deposit their remaining kinetic energy in the cooled substrate. The, presently claimed invention also introduces novel geometry intended to confer symmetry around the beam axis of the resulting neutron fields—a feature particularly relevant to utilization of the invention in boron-neutron capture therapy (BNCT).

Other objects, advantages and novel features, and further scope of applicability of the presently claimed invention will be set forth in part in the detailed description to follow, taken in conjunction with the accompanying drawings, and in part will become apparent to those skilled in the art upon examination of the following, or may be learned by practice of the claimed invention. The objects and advantages of the claimed invention may be realized and attained by means of the instrumentalities and combinations particularly pointed out in the appended claims.

### BRIEF DESCRIPTION OF THE DRAWINGS

The accompanying drawings, which are incorporated into and from part of the specification, illustrate the embodiment of the presently claimed invention and, together with the description, serve to explain the principles of the claimed invention. The drawings are only for the purpose of illustrating an embodiment of the claimed invention and are not to be construed as limiting the claimed invention. In the drawings:

FIG. 1 is a cross-sectional diagram of a preferred embodiment of the presently claimed invention, a proton target system for producing neutrons.

FIG. 2 illustrates a heat exchanger that constitutes part of the preferred embodiment of the presently claimed invention.

FIG. 3A illustrates the conical heat exchanger separated from the coolant manifold.

FIG. 3B shows the embodiment of FIG. 3A with the heat exchanger mounted on the coolant manifold.

FIG. 3C shows a cutaway view of the embodiment of FIG. 3B.

FIG. 4 is a graph of peak temperatures (in Kelvin) on the target surface versus flow rates for water heat exchangers for the present target system, as determined by computational models.

### DESCRIPTION OF THE PREFERRED EMBODIMENT

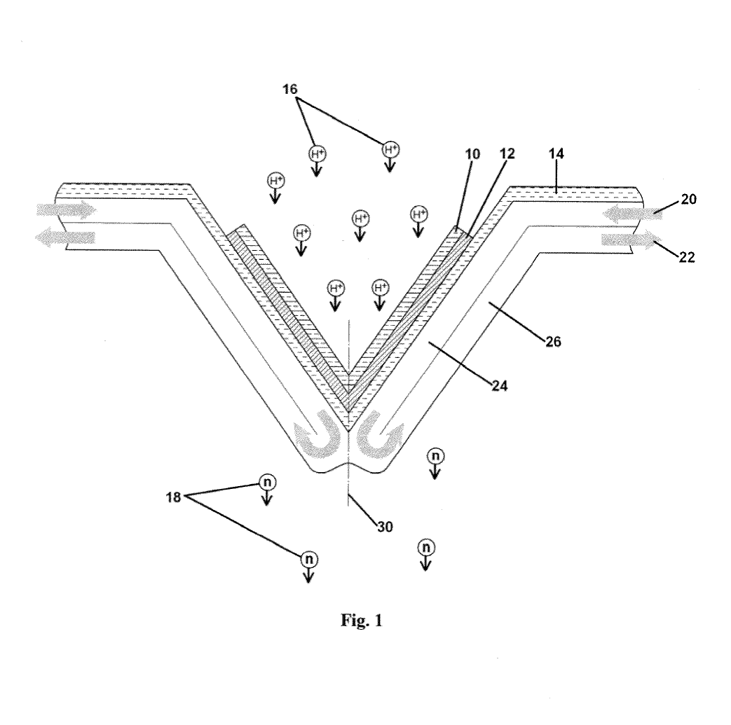

FIG. 1 is a cross-sectional diagram of a preferred embodiment of the presently claimed invention, a proton target system for producing neutrons. The apparatus is symmetric about an axis of revolution 30. Energetic protons 16 bombard a conical target layer of lithium metal 10 where they produce neutrons 18 by the Li-7(p,n) nuclear reaction. The thickness of the lithium layer is limited such that protons slowed below the Li-7(p,n) reaction threshold at 1.88 MeV exit through the downstream side of the layer into a substrate of a hydrogen diffusing and/or absorbing material, e.g. palladium 12. This substrate is thick enough to completely stop the proton beam. The substrate layer is not necessary, but may be important in limiting the degradation of heat exchanger materials by implantation of hydrogen and diffusion of lithium: A heat exchanger 14, made of copper or other metal of suitable thermal conductivity, conducts heat from the lithium and substrate (if present) to a coolant duct 24. Heat exchanger 14 preferably contains a channelized volume as shown in subsequent figures, in which case coolant duct 24 represents the channels. Coolant 20 entering the target system passes through heat exchanger 14, reverses direction, and exits target system 22 via an exterior duct 26. The arrangement of coolant ducts suggested in this figure preserves azimuthal symmetry of the target system, resulting in azimuthally-symmetric neutron flux downstream of the target system. In addition, large volumes of coolant between the lithium layer and any downstream neutron applications are avoided.

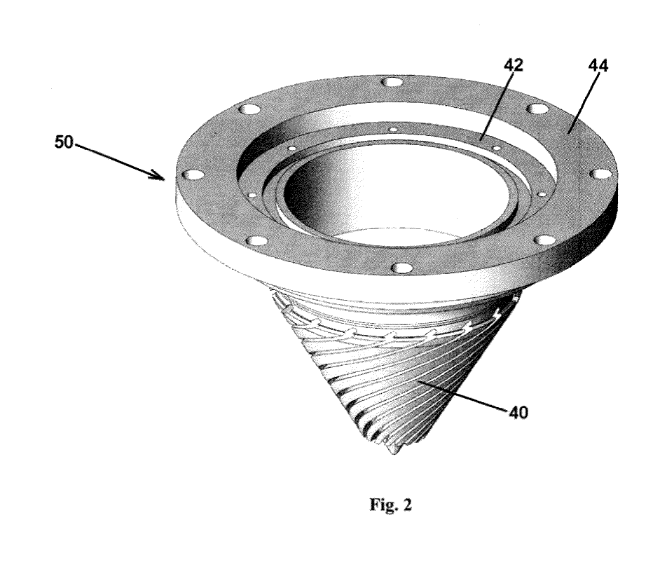

FIG. 2 illustrates heat exchanger 14 that constitutes part of the preferred embodiment of the presently claimed invention. Heat exchanger 14 is conical with a helically-channelized exterior 40. The example in the figure contains twenty channels through which coolant passes. Although twenty channels are shown, this number can be varied and is not meant to limit the claimed embodiments to this number. The upstream end of the heat exchanger contains two o-ring flanges 42 and 44. Interior flange 42 is the means by which the heat exchanger is coupled to the proton beamline. Exterior flange 44 couples the heat exchanger to a coolant manifold. The heat exchanger may be removed in its entirety from the plumbing of the heat removal system simply by breaking exterior flange 44. The simplicity of this demounting process is advantageous after the target system has been operated and induced radioactivity has accumulated in its components.

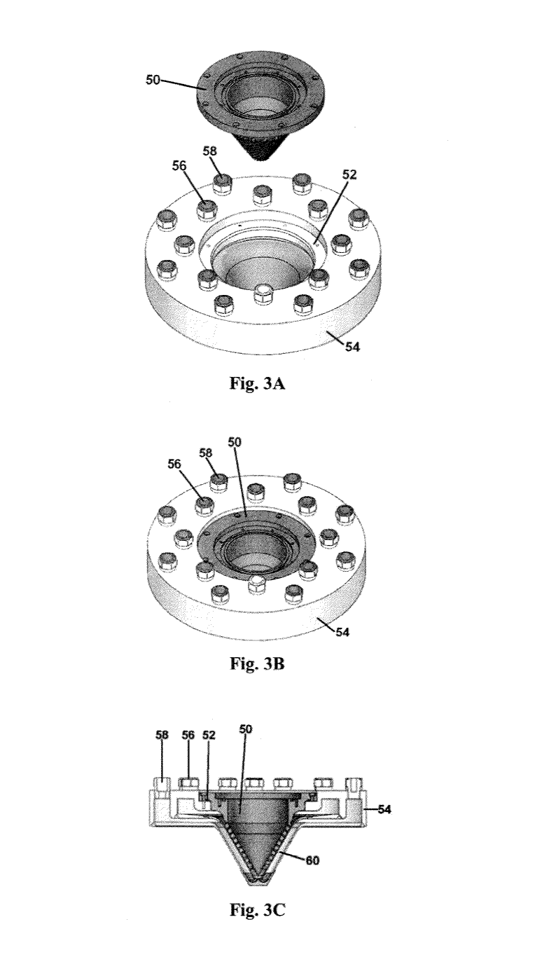

FIGS. 3A, 3B and 3C illustrate the assembly. FIG. 3A shows conical heat exchanger 50 carrying the lithium target layer and substrate layer, separated from coolant manifold 54. In FIG. 3B, heat exchanger 50 is shown mounted into coolant manifold 54 by means of an o-ring flange 52. Water inlets 56 and outlets 58 carry coolant to and from the system. In FIG. 3C, a cutaway view is provided that shows the structure of the coolant ducts 60.

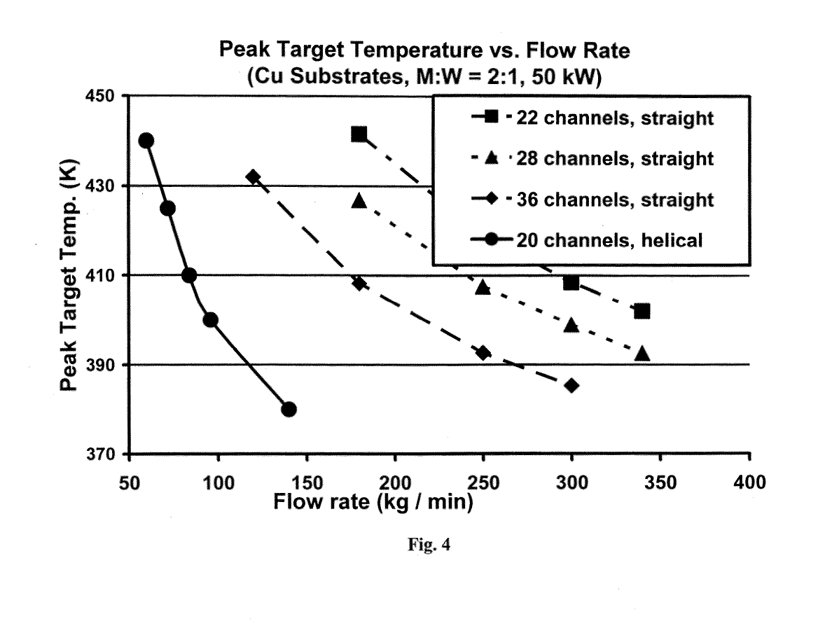

FIG. 4 is a graph of peak temperatures (in Kelvin) on the target surface versus flow rates for water heat exchangers for the present target system, as determined by computational models. Embodiments with straight tangential channels (22, 28, or 32 channels), as well as the preferred embodiment with helical channels, are shown. All of these embodiments entail bombardment of the target surface with 50-kW, 8-cm-diameter static proton beams having a pseudo Gaussian power density distributions commonly delivered by rf linear accelerators. The melting point of the lithium target layer is 453 Kelvin, so it is evident that the embodiments shown in this figure are capable of maintaining the lithium metal in the solid state.

The target layer is preferably a layer of lithium (e.g. 100 μm in the beam direction for 2.5-MeV protons) that engages in the Li-7(p,n) reaction and reduces the transmitted proton beam to the threshold of neutron production at 1.88 MeV. Such a layer may be formed by physical vapor deposition (PVD) of lithium upon the substrate in vacuo, or by other means well known in the art.

The target substrate is preferably a palladium metal layer electroplated onto the heat exchanger, thick enough to fully stop the proton beam (15-20 μm in the beam direction for 1.88-MeV protons).

Heat exchanger 50 is a conical copper shell having helical channels (about the cone axis) for water coolant on the exterior. Linear tangential channels may be used, but computational fluid dynamics (CFD) modeling shows that practical embodiments using linear channels result in inferior heat transfer in comparison with the helical configuration. Copper is chosen for its excellent thermal conductivity and acceptable short-lived neutron activation products. The interior of the heat exchanger cone supports the substrate and target layers. In the preferred embodiment, heat exchanger 50 is demountable from the cooling system manifold so that it may be replaced quickly and easily without manipulating the plumbing of the cooling system, as shown in FIGS. 3A and 3B.

The coolant is preferably water or heavy water (D₂O). The latter may find use in situations where degradation of the neutron flux and energy spectrum by scattering and/or capture of neutrons by hydrogen (predominantly H-1) in ordinary water is disadvantageous.

Finally, the heat removal system of the preferred embodiment employs a central manifold, with which the heat exchanger mates that returns the flow of coolant exiting the apex ends of the heat exchanger channels via an outer conical-annular return duct. The manifold is made with or coated with a material that is not electrochemically reactive in an aqueous environment with copper.

### EXAMPLES (INDUSTRIAL APPLICABILITY)

The presently claimed invention is further illustrated by the following non-limiting examples.

### Example 1

An example of the preferred embodiment of the invention, designed to operate with a static, expanded, 2.5-MeV/20-mA (50 kW) proton beam from an accelerator, is described.

Referring to FIG. 2, a copper heat exchanger cone 50 of base diameter of 10 cm and opening angle of 60 degrees contains 20 helical channels 40 of constant width (2 mm), depth (6 mm normal to cone surface), and pitch (one-half turn about the cone axis) on its exterior. The interior is electroplated with 10 μm of palladium (i.e. 20 μm in the beam direction), and the palladium is in turn coated under vacuum with 50 μm of lithium metal (i.e. 100 μm in the beam direction) by vapor deposition.

Heat exchanger 50, substrate, and target assembly described above mates with a coolant manifold 54 fabricated from aluminum that has been electroless nickel plated to protect it from galvanic corrosion, as shown in FIGS. 2A, 3B and 3C. A water-to-air seal is effected between heat exchanger 50 and coolant manifold 54 with an o-ring and bolt flange 52. By removing the flange bolts, heat exchanger 50 may be liberated from all coolant plumbing. Coolant manifold 54 contains eight ¾-inch NPT pipe fittings distributed symmetrically on intake side 56, and eight ¾-inch NPT pipe fittings on outlet side 58, to interface with the rest of a coolant loop containing an ultimate heatsink and pump. The coolant is ordinary treated water.

In operation, the incident proton beam is assumed to have a pseudo-Gaussian power density distribution, typical of many bunched radiofrequency linear accelerators, with a peak-to-average ratio of 1.5. The beam diameter is 8 cm at the target. The system is supplied with water at 80 liters per minute at room temperature (25 degrees Celsius) by a 3-HP centrifugal pump. Experiment and CFD modeling indicate that such a flow rate results in a pressure drop across the target heat exchanger of 150 kPa (22 psi). Peak temperature at the copper-substrate interface is predicted by CFD modeling to be 145 degrees Celsius, well below the melting point of lithium metal at 180.5 degrees Celsius. This operating point is intended to allow the target to be operated for short periods without removal of heat from the coolant to an ultimate heatsink, allowing heat to be stored temporarily in the recirculating coolant and thereby raise its temperature to 35 degrees Celsius. Available nuclear cross-section data and experimental reports suggests that such a target can be expected to produce 1.7×10¹³ neutrons per second with a maximum energy of 800 keV and flux-weighted mean energy of 330 keV.

### Example 2

Referring to FIGS. 2, 3A, 3B and 3C, a target heat exchanger 50 was fabricated from oxygen-free electronic (OFE) copper, having an interior conical surface with opening angle of 60 degrees and a diameter of 10 cm to support the target and substrate layers. The conical interior of heat exchanger 50 was electroplated with 40 μm of palladium to act as the hydrogen-diffusing substrate. Twenty (20) channels 40 for cooling water, each 0.6 cm×0.2 cm in cross-section, were milled into the exterior of the heat exchanger. Heat exchanger 50 fits into an azimuthally-symmetric coolant manifold 54 that directs coolant into and out of channels 40. Computational fluid dynamics calculations made in COSMOS FloWorks show that with 50 kW of beam heating and a pseudo-Gaussian power density distribution, the peak target surface temperature remains below 150 deg. Celsius—and thus a lithium layer will remain solid with considerable safety margin—at a flow rate of 80 kg min⁻¹ through target heat exchanger 50. A coolant mass flow rate of 80 kg min⁻¹ was found to correspond to a pressure drop across the target heat exchanger of 170 kPa (25 psi). This pressure and flow is readily obtained with a small centrifugal pump (not shown).

Lithium may be deposited on the substrate by physical vapor deposition or by other techniques well known in the art. A magnetically-expanded waterbag distribution of protons incident on the target with energy of 2.5 MeV and total current of 20 mA (beam power of 50 kW) is expected to yield 1.7×10¹³ neutrons per second from the target, according to experimental yield data from Liskien. These neutrons have a flux-weighted mean energy of 0.33 MeV and a maximum energy of about 0.80 MeV. With appropriate lead reflectors and a polytetrafluoroethylene moderator, a BNCT treatment flux in excess of 2×10⁹ neutrons cm⁻² second⁻¹ in the epithermal band (0.5 eV-10 keV) is calculated with the Monte Carlo code MCNPX. Neutron beam quality and intensity meet the suggested criteria for clinical BNCT proposed in IAEA-1223.

The previous description of the disclosed embodiment is provided to enable any person skilled in the art to make or use the presently claimed invention. Various modifications to these embodiments will be readily apparent to those skilled in the art, and the generic principles defined herein may be applied to other embodiments without departing from the spirit or scope of the presently claimed invention. Thus, the presently claimed invention is not intended to be limited to the embodiments shown herein, but is to be accorded the widest scope consistent with the principles and novel features disclosed herein.

What is claimed is:

1. A target system, comprising a target and heat removal structure, for production of neutrons of sub-MeV energies from high-intensity (>1 MW m⁻²) proton beams by the Li-7(p,n) reaction, in which the target material is a layer of lithium metal mechanically supported and maintained in the solid state by the heat-removal structure.
